(19) United States
(12) Patent Application Publication
(10) Pub. No.: US 2008/0189754 A1
(43) Pub. Date: Aug. 7, 2008

(54) Pod Identification Method in Digital Content Providing System

(76) Inventors: Kyoung-ro Yoon, Seoul (KR); Sun-young Han, Seoul (KR); Hee-Kyung Lee, Daejeon (KR); Jung-won Kang, Seoul (KR); Jae-gon Kim, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/817,983

(22) PCT Filed: Mar. 9, 2006
(86) PCT No.: PCT/KR06/00842

§ 371 Date: Sep. 7, 2007

(30) Foreign Application Priority Data
Mar. 10, 2005 (KR) 10-2005-0020108

(51) Int. Cl. H04N 7/173

(52) U.S. Cl. 725/105

(57) ABSTRACT

Provided is a commercial break identification method in a digital content providing system. The method for identifying commercial break in a digital content providing system includes the steps of: a) generating segment metadata including Pod identification information (PodId) identifying the Pod in a digital content; and b) transmitting the segment metadata and the digital content to a user terminal.

### TECHNICAL FIELD

The present invention relates to a commercial break identification method in a digital content providing system; and, more particularly, to a method for identifying a location of commercial break in a digital content in a digital content providing system such as a TV-Anytime (TVA).

### BACKGROUND ART

As broadcasting is digitalized, broadcasting environments are changing from conventional uni-directional broadcasting reception to multimedia, multichannel, and even complicated broadcasting forms accommodating diverse reception terminals through connection between a broadcasting network and a communication network. Broadcasting viewers demand to get out of passive watching broadcasting programs through limited channel selection and participate in broadcasting services, namely, receiving and watching desired programs at desired time.

The change shows that the broadcasting environments are evolving into diverse, complicated and personalized forms. Personalized broadcasting makes the viewers consume desired broadcast contents at desired time in desired formats with diverse terminals conveniently and efficiently according to the viewers' preferences in the new, diverse and complicated broadcasting environments. In other words, the personalized broadcasting provides broadcast contents customized to a usage environment including user preference, terminal performance, network characteristics, and a natural environment such as time, place and the mood of a viewer.

TV-Anytime (TVA) Forum is a group for setting up standards for personalized broadcasting. The TVA Forum is a private standards organization established in September 1999 to develop standards for audio visual related services in a user environment equipped with a personal digital recorder (PDR).

The standards for personalized broadcasting in the TVA Forum is categorized into two phases, i.e., Phase1 (TVA-1) and Phase2 (TVA-2), in the respect of an assumed system environment and major functions to be provided.

TVA-1 provides application programs such as search, selection, acquisition and consumption of audio/video (AV) contents with a PDR in an environment where a main broadcasting program is transmitted through a uni-directional broadcasting channel and additional metadata are acquired through a bi-directional network.

The metadata are descriptive data on contents including the tile, genre and overview of a program. Generally, metadata are defined as data about data.

TVA-2 extends the broadcasting consumption environment of the TVA-1 which assumes a uni-directional broadcasting channel and a bi-directional network, and provides not only AV programs, which used to be major service objects of the TVA-1, but also a package of application programs, Pod, and diverse forms of media components such as image and text.

Interstitial contents and interstitial metadata for providing a personalized Pod service are under discussion in the TVA-2. However, there is a problem that the TV-Anytime does not provide any mechanism for signaling the Pod identification (ID) information of the Pod in broadcasting stream.

Herein, the interstitial contents indicate contents that are additionally added to the beginning or end of a main content or between main contents. The interstitial contents usually refer to Pod contents. Also, the interstitial metadata are data which describe the interstitial contents. The interstitial usually refer to data that describe the Pod contents, and they are metadata that are mainly used for changing interstitial contents, which will be described later.

Meanwhile, Pod means a set of Avails and Spots that form a commercial break, and the Pod should be provided to users based on its own identification information. Herein, Avail is a term used in the United States to describe an individual interstitial item within for example a commercial break and it is also commonly known as a ‘Spot,’ which means an individual content item within an interstitial break. In the United Kingdom, an avail means an interstitial break.

However, it is problematic that there is no standardized mechanism for signaling or identifying Pod in a digital content providing system such as a VoD service or an IP-TV service. Thus, it is required to establish a standardized mechanism for signaling and/or identifying Pod to prepare for a case when new business models for a VoD service or an IP-TV service with the interstitial contents added thereto are provided.

Meanwhile, the VoD service and/or IP-TV service can be easily transformed into an open market using standard open protocol such as TCP/IP and RTSP/RTP.

The standard open protocol will be described in detail hereinafter.

Real-time Transport Protocol (RTP) is a protocol used for transmission of multimedia data such as audio and video which should be transmitted in real-time. Real-time transmission requires a sequence numbering function, a timestamping function, and a delivery monitoring function. The RTP is a protocol for the functions. RTP, which is first designed for multimedia video conference among a plurality of users, can be applied to storing, controlling and output of data. According to RTP, since data are transmitted in an IP level along with sequence numbers and time information, data out of a sequence or lost data can be detected and data restoration time can be known precisely. The RTP is not realized as an independent level, but it is rather designed to be realized and processed by a particular application program. Since RTP is not a protocol for delivering data sequentially or on time, it does not guarantee the quality of data transmission. Instead, it monitors data transmission based on the RTP Control Protocol (RTCP) and provides a control function and a media identification function which are minimally required. The functions control the flow of data. Also, RTP provides such functions as a mixer and a translator to control a bandwidth according to the network condition. The mixer function is performed with respect to audio data only. The mixer function mixes data of RTP packets having the same destination and adds a common header to the mixed data. Differently from the mixer function, the translator function controls the quantity of data by changing a CODEC of data and it does not fix the RTP header.

The RTCP is a protocol for maintaining the quality of service (QoS) of RTP. RTP involves in data transmission, whereas RTCP monitors data transmission and involves in transmission of session associated information. RTP nodes analyze the network condition and transmit RTCP packets to each other to periodically report whether there is network congestion. Since both RTP and RTCP are operated based on a User Datagram Protocol (UDP), characteristically, they cannot guarantee data quality and provide high reliability and a transmission blocking function, and they transmit data out of a predetermined sequence. However, since they can provide a timestamping function which is needed for real-time application and a media synchronization function, almost all applications using real-time information on the Internet, such as VOD, AOD, Internet broadcasting, and video conference, adopt the RTP and the RTCP.

Real-Time Streaming Protocol (RTSP) is a protocol of an application level which transmits media data in real-time in an on-demand format. RTSP is a standard protocol of streaming technology for controlling streaming data on the Internet. The specification is join-developed by the Netscape Corporation, the Real Network Company, and the Columbia University in 1998 and registered in the Internet Engineering (IETF) as standard. RTSP uses RTP to designate the multimedia content packet format, which is similar to H.323. Whereas H.323 is designed for video conference between groups of a predetermined size, RTSP is designed to efficiently broadcast video and audio data to large groups.

As described above, when it is assumed that interstitial content replacement service is provided in the field of VoD and IP-TV services that can be easily transformed into an open market using the standard open protocols such as TCP/IP and RTSP/RTP, there is a problem that it is very difficult to realize a set-top box that can provide a multimedia VoD/IP-TV service without a consistent Pod identification mechanism. Herein, the interstitial content replacement means replacing interstitial contents that have been included in broadcast contents stored in a personal digital recorder (PDR) of a user terminal with other preferred interstitial contents when the broadcast contents are restored or deleting the existing interstitial contents.

### Disclosure

### Technical Problem

It is, therefore, an object of the present invention to provide a Pod identification method for identifying Pod by using segment metadata in a digital content provided by a digital content providing system.

It is another object of the present invention to provide a Pod identification method for identifying Pod by using Pod identification information of a Uniform Resource Identifier (URI) type in a digital content provided by a digital content providing system.

Other objects and advantages can be understood by the following description and they will become apparent with reference to the accompanying drawings. Also, those skilled in the art of the present invention can easily understood that the objects and advantages of the present invention can be realized by the means as claimed and combinations thereof.

### Technical Solution

In accordance with one aspect of the present invention, there is provided a method for identifying Pod in a digital content providing system, which includes the steps of: a) generating segment metadata including Pod identification information (PodId) identifying the Pod in a digital content; and b) transmitting the segment metadata and the digital content to a user terminal.

In accordance with another aspect of the present invention, there is provided a method for identifying Pod in a digital content providing system, which includes the steps of: a) receiving a digital content and segment metadata; b) extracting segment group information (SegmentGroupInformation) from the segment metadata; and c) acquiring Pod identification information (PodId) for positioning the Pod in the digital content from the SegmentGroupInformation.

In accordance with another aspect of the present invention, there is provided a method for identifying Pod in a digital content providing system, which includes the steps of: a) generating a packet header of a digital content which includes Pod location information (PodLocator), which is information on where the Pod is to be inserted; b) generating PodId of the Pod inserted into the digital content in a URI type and adding the PodId to the packet header; and c) transmitting the packet header of the digital content.

In accordance with another aspect of the present invention, there is provided a method for identifying Pod in a digital content providing system, which includes the steps of: a) receiving a packet of a digital content; b) extracting a packet header from the packet; c) acquiring Pod location information (PodLocator), which is information on where the Pod is to be inserted in the digital content, from the packet header; and d) acquiring Pod identification information (PodId) of a URI type from the packet header.

### Advantageous Effects

The present invention described above can identify Pod in a digital content easily and economically without an additional unit to a system by using TVA-based segment metadata.

Also, the present invention can easily identify Pod without any modification and addition to the current TVA specification by providing Pod identification information by using TVA segment metadata, i.e., ‘SegmentGroupInformation,’ even though there are no transmission system resources for Pod identification.

In addition, the present invention can be used as an additional mechanism for supporting interstitial content replacement in an open market based on open standard protocols where contents are transmitted in a simple manner, such as TCP/IP and RTSP/RTP.

The present invention can identify Pod in a digital content by using URI-type Pod identification information.

### DESCRIPTION OF DRAWINGS

The above and other objects and features of the present invention will become apparent from the following description of the preferred embodiments given in conjunction with the accompanying drawings, in which:

FIG. 1 is a block diagram illustrating the entire digital content providing system to which the present invention is applied;

FIG. 2 is a flowchart describing a Pod identification process using segment metadata for open service in accordance with an embodiment of the present invention; and

FIG. 3 is a flowchart describing a Pod identification process using URI-type Pod identification information for broadcasting services in accordance with an embodiment of the present invention.

### BEST MODE FOR THE INVENTION

Other objects and aspects of the invention will become apparent from the following description of the embodiments with reference to the accompanying drawings, which is set forth hereinafter.

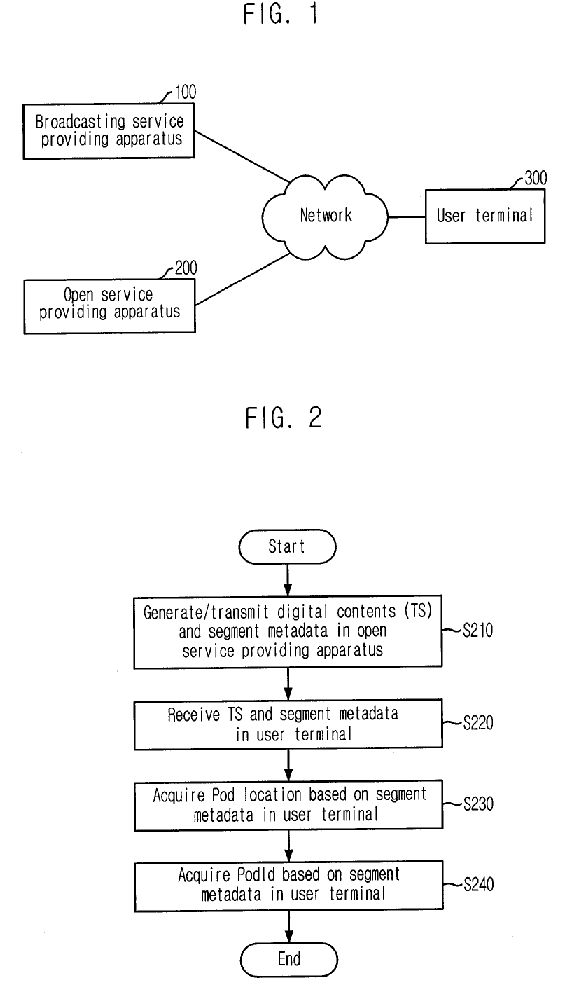

FIG. 1 is a block diagram illustrating the entire digital content providing system to which the present invention is applied.

Referring to FIG. 1, the digital content providing system of the present invention includes a broadcasting service providing apparatus 100, an open service providing apparatus 200, and a user terminal 300.

The user terminal 300 is connected to the broadcasting service providing apparatus 100 or the open service providing apparatus 200 through a network which is formed of a broadcasting channel and/or bi-directional Internet Protocol (IP) network. The user terminal 300 receives signaled Pod identification (ID) information and interstitial metadata and performs Pod replacement to provide a personalized Pod service.

The broadcasting service providing apparatus 100 is a digital broadcasting service providing device that follows transmission standards such as Digital Video Broadcasting (DVB), Advanced Television System Committee (ATSC) and Association of Radio Industries and Businesses (ARIB) and transmits Pod identification information of a Uniform Resource Identifier (URI) to perform signaling onto the Pod identification information in a digital content. The URI includes a Uniform Resource Locator (URL) and a Uniform Resource Name (URN). The URL indicates an actual network route and it is used to access to resources on the network. The first part of the URL specifies protocol, which is http in most cases, ftp or mailto, occasionally, or gopher, news, telnet or file in unusual cases. The URL protocol part is called ‘scheme.’ The scheme is followed by colon (:) which is also followed by route of an identified resource, for example, http://www.xmlgo.net/document/editor/editor.html. The each resource has a persistent and unique URN and the URN provides an independent name to each location. This is defined in RFC 2141 at http://www.ietf.org/rfc/rfc2141.txt. URN is formed of a text sequence ‘urn’ or ‘URN,’ a namespace identifier (NID), and a namespace specific string (NSS) and colon (:) is placed between constituent elements, for example, urn:xmlgo:registry1.

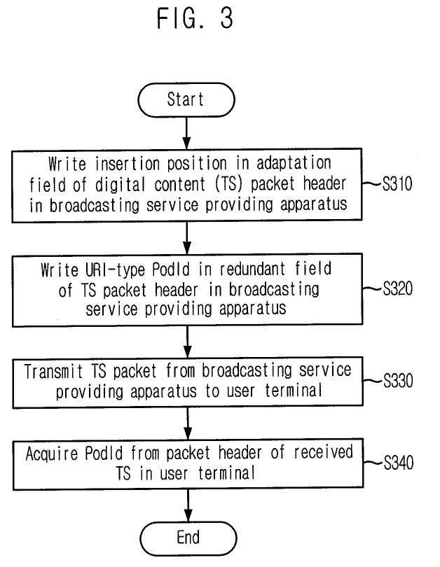

A Pod identification process in the broadcasting service providing apparatus 100 will be described later in detail with reference to FIG. 3.

The open service providing apparatus 200 is an apparatus for providing digital broadcasting services, e.g., VOD or IP-TV, which transmits contents based on open standard such as TCP/IP and RTSP/RTP in an environment having no dominant convent provider. The open service providing apparatus 200 performs signaling onto Pod identification information based on segment metadata, which are defined in the TVA-1, and the Pod identification information is of a Content Reference Identifier (CRID) type and it provides ‘ProgramRef’ and ‘segmentId’ of segment group information (SegmentGroupInformation).

The open service providing apparatus 200 basically uses metadata defined in the TVA, and a major part of what is defined in the TVA in connection with the present invention is revealed in the ETSI TS 102 822-3-1 V1.2.1, September 2004, entitled “Broadcast and On-line Services: Search, Select, and rightful use of content on personal storage systems (TV-Anytime Phase 1), Part 3: Metadata; Sub-part 1: Metadata schemes. The major part will be described hereinafter.

TVA defines segmentation that can define and access to a predetermined section of AV stream, i.e., a digital content.

AV obtained from the process of AV segmentation is called a segment, and a bunch of segments is called an AV segment group. Metadata about the segmentation is called segment metadata, and there are two types of segment metadata: segment information (SegmentInformation) and segment group information (SegmentGroupInformation).

‘SegmentInformationTable’ provides information on a segment, such as overview, title and keywords. ‘SegmentId’ is a segment identifier, and ‘ProgramRef’ is reference information indicating a program including the segment.

The ‘SegmentGroupInformation’ provides information on a segment group, such as overview, title and keywords. It includes ‘GroupType’ which informs what attribute unites the segments of a group into a group. In overall, the ‘SegmentGroupInformation’ has a similar structure as the ‘SegmentInformationTable.’

FIG. 2 is a flowchart describing a Pod identification process using segment metadata for open service in accordance with an embodiment of the present invention.

First of all, the open service providing apparatus 200 generates segment metadata including ‘SegmentInformation’ and ‘SegmentGroupInformation’ based on the TVA Standard Specification and transmits them along with digital contents, which are transmitted in the form of transport stream (TS), in step S201.

Subsequently, the user terminal 300 receives the transmitted digital contents and segment metadata in step S220, and acquires the location of Pod from the ‘SegmentInformation’ of the received segment metadata in step S230. To be specific, the user terminal 300 acquires the location of Pod from ‘SegmentLocator’ of ‘SegmentInformation.’

Subsequently, the user terminal 300 acquires ‘PodId’ from the ‘SegmentGroupInformation’ of the received segment metadata in step S230. To be specific, the user terminal 300 acquires CRID-type PodId from ‘SegmentId’ and ‘ProgramRef’ of the ‘SegmentGroupInformation.’

Through the above processes, the user terminal 300 can acquire Pod identification information (PodId) and location of Pod which is desired to be replaced or deleted.

A process for identifying Pod for providing an open service by using segment metadata will be described hereinafter with reference to an exemplary segment metadata having an eXtensible Markup Language (XML) syntax as shown below.

<?xml version=“1.0” encoding=“UTF-8”?>
<TVAMain xmlns=“urn:tva:metadata:2005” xmlns:tva2=“urn:tva:metadata:Phase2:2005”
xmlns:mpeg21=“urn:mpeg:mpeg21:2003:01-DIA-NS”
xmlns:mpeg7=“urn:mpeg:mpeg7:schema:2001” xmlns:xsi=“http://www.w3.org/2901/XMLSchema-
instance” xsi:schemaLocation=“urn:tva:metadata:Phase2:2005 tva2_20050212.xsd”>

<ProgramDescription>

<SegmentInformationTable>

<SegmentList>

<SegmentInformation segmentId=“segment01”>

<ProgramRef crid=“crid://ybc.com/myprogram1”/>
<SegmentLocator>

<MediaRelIncrTimePoint>30000</MediaRelIncrTimePoint>

</SegmentLocator>

</SegmentInformation>
<SegmentInformation segmentId=“segment02”>

<ProgramRef crid=“crid://ybc.com/myprogram1”/>
<SegmentLocator>

<MediaRelIncrTimePoint>60010</MediaRelIncrTimePoint>

</SegmentLocator>

</SegmentInformation>
<SegmentInformation segmentId=“segment03”>

<ProgramRef crid=“crid://ybc.com/myprogram1”/>
<SegmentLocator>

<MediaRelIncrTimePoint>100000</MediaRelIncrTimePoint>

</SegmentLocator>

</SegmentInformation>
<SegmentInformation segmentId=“segment04”>

<ProgramRef crid=“crid://ybc.com/myprogram1”/>
<SegmentLocator>

<MediaRelIncrTimePoint>142000</MediaRelIncrTimePoint>

</SegmentLocator>

</SegmentInformation>
<SegmentInformation segmentId=“segment05”>

<ProgramRef crid=“crid://ybc.com/myprogram1”/>
<SegmentLocator>

<MediaRelIncrTimePoint>183000</MediaRelIncrTimePoint>

</SegmentLocator>

</SegmentInformation>

</SegmentList>
<SegmentGroupList>

<SegmentGroupInformation groupId=“sgroup001”>

<ProgramRef crid=“crid://ybc.com/myprogram1”>
<GroupType xsi:type=“SegmentGroupTypeType” value=“insertionPoints”/>
<Segments refList=“segment01 segment02 segment03 segment04 segment05”/>

</SegmentGroupInformation>

</SegmentGroupList>

</SegmentInformationTable>

</ProgramDescription>

</TVAMain>

The above exemplary segment metadata provide locations and PodIds of five Pods. As described above, the ‘segmentId’ and ‘ProgramRef’ of the segment metadata are used as ‘PodId.’ ‘MediaRelIncrTimePoint’ of the ‘SegmentLocator’ can provide the exact location of Pod.

The above exemplary segment metadata will be described more in detail hereinafter by reciting corresponding syntax parts.

<SegmentGroupInformation groupId=“sgroup001”>

<ProgramRef crid=“crid://ybc.com/myprogram1”/>
<GroupType xsi:type=“SegmentGroupTypeType” value=“insertionPoints”/>
<Segments refList=“segment01 segment02 segment03 segment04 segment05”/>

</SegmentGroupInformation>

Referring to the XML syntax of the ‘SegmentGroupInformation’ of the segment metadata, it can be seen that a program identified as ‘crid://ybc.com/myprogram1’ has five segments of ‘insertionPoints’ type from ‘segment01’ to ‘segment05,’ each of which corresponds to a location where a predetermined content can be inserted. The user terminal positions commercial break (Pod/interstitial break) based on the information of the location where a predetermined content can be inserted, which is used for inserting a content. In other words, the ‘segment01’ to ‘segment05’ corresponds to the starting location of Pod01 to Pod05, respectively.

<SegmentInformation segmentId=“segment03”>

<ProframRef crid=“crid://ybc.com/myprogram1”/>
<SegmentLocator>

<MediaRelIncrTimePoint>100000</MediaRelIncrTimePoint>

</SegmentLocator>

</SegmentInformation>

Referring to the XML syntax of the segment metadata, it can be seen from the ‘SegmentId,’ ‘ProgramRef,’ and ‘MediaRelincrTimePoint’ that ‘PodId’ is ‘segment03’ and the location of ‘Pod03,’ which is the third Pod corresponding to ‘crid://ybc.com/myprogram1,’ is located at about 55 minutes past from the beginning of a program in the user terminal. The 55 minutes is 100,000/30/60 where ‘30’ denotes the number of frames per second and ‘60’ denotes the number of seconds per minute.

In the present embodiment, both ‘SegmentId’ and ‘ProgramRef’ are used as ‘PodId,’ but it is possible to use only the ‘SegmentId’ as the ‘PodId.’ However, when the uniqueness of the ‘PodId’ cannot be secured only with the ‘SegmentId,’ it is desirable to use the ‘ProgramRef’ and the ‘SegmentId’ together as the PodId.

FIG. 3 is a flowchart describing a Pod identification process using URI-type Pod identification information (PodId) for broadcasting services in accordance with an embodiment of the present invention.

First of all, in step S310, when the broadcasting service providing apparatus 100 inserts Pod into a main broadcasting program, i.e., splicing, it registers the location where the Pod is spliced in ‘splice_countdown’ of an adaptation field of a packet header of a digital content, which is in the form of transport stream. Herein, the ‘splice_countdown’ is a positive or negative integer, and a positive value indicates the number of TS packets remaining from the current TS packet to a splicing point, whereas a negative value indicates the number of TS packets past from the splicing point.

Also, in step S320, the broadcasting service providing apparatus 100 registers PodId of a URI type in a redundant field of a TS packet header to inform which Pod a packet belongs to. Then, in step S330, it transmits TS packets to the user terminal.

Subsequently, the user terminal 300 acquires the content of the ‘splice_countdown’ from the received TS packet header, confirms the starting point of the Pod, and acquires the URI-type PodId from the redundant field of the TS packet header.

As described above, the method of the present invention can be realized as a program and stored in a computer-readable recording medium, such as CD-ROM, RAM, ROM, floppy disks, hard disks, and magneto-optical disks. Since the process can be easily implemented by those skilled in the art of the present invention, further information will not be provided herein.

While the present invention has been described with respect to certain preferred embodiments, it will be apparent to those skilled in the art that various changes and modifications may be made without departing from the scope of the invention as defined in the following claims.

### INDUSTRIAL APPLICABILITY

The technology of the present invention is applied to TV-Anytime (TVA) systems.

1. A method for identifying commercial break in a digital content providing system, comprising the steps of:
a) generating segment metadata including Pod identification information (PodId) identifying the Pod in a digital content; and
b) transmitting the segment metadata and the digital content to a user terminal.

2. The method as recited in claim 1, wherein the segment metadata include segment group information (SegmentGroupInformation) which includes the PodId.

3. The method as recited in claim 2, wherein the PodId is a Content Reference Identifier (CRID) type.

4. The method as recited in claim 2, wherein the PodId includes segment identification (SegmentId) of the SegmentGroupInformation.

5. The method as recited in claim 4, wherein the PodId further includes program reference information (ProgramRef) which belongs to the SegmentGroupInformation.

6. The method as recited in claim 1, further comprising the step of:
c) generating segment metadata including Pod location information (PodLocator),
wherein the segment metadata further include segment information (SegmentInformation) having the PodLocator.

7. The method as recited in claim 6, wherein the PodLocator is provided by using segment location information (SegmentLocator) of the SegmentInformation.

8. A method for identifying commercial break in a digital content providing system, comprising the steps of:
a) receiving a digital content and segment metadata;
b) extracting segment group information (SegmentGroupInformation) from the segment metadata; and
c) acquiring Pod identification information (PodId) for positioning the Pod in the digital content from the SegmentGroupInformation.

9. The method as recited in claim 8, wherein the PodId is a CRID type.

10. The method as recited in claim 8, wherein the PodId includes segment identification (SegmentId) of the SegmentGroupInformation.

11. The method as recited in claim 10, wherein the PodId further includes program reference information (ProgramRef) which belongs to the SegmentGroupInformation.

12. The method as recited in claim 8, further comprising the steps of:
d) extracting segment information (SegmentInformation) from the segment metadata; and
e) acquiring Pod location information (PodLocator) from the SegmentInformation.

13. The method as recited in claim 12, wherein the PodLocator is acquired by using the segment location information (SegmentLocator) of the SegmentInformation.

14. A method for identifying commercial break in a digital content providing system, comprising the steps of:
a) generating a packet header of a digital content which includes Pod location information (PodLocator), which is information on where the Pod is to be inserted;
b) generating PodId of the Pod inserted into the digital content in a URI type and adding the PodId to the packet header; and
c) transmitting the packet header of the digital content.

15. The method as recited in claim 14, wherein the PodLocator is included in an adaptation field of the packet header.

16. The method as recited in claim 15, wherein the PodId is included in a redundant field of the packet header.

17. A method for identifying commercial break in a digital content providing system, comprising the steps of:
a) receiving a packet of a digital content;
b) extracting a packet header from the packet;
c) acquiring Pod location information (PodLocator), which is information on where the Pod is to be inserted in the digital content, from the packet header; and
d) acquiring Pod identification information (PodId) of a URI type from the packet header.

18. The method as recited in claim 17, wherein the PodLocator is acquired by using content of an adaptation field of the packet header.

19. A computer readable storage medium containing a metadata for identifying commercial break in a digital content providing system, the metadata comprising:
Pod identification information (PodId) identifying the Pod in a digital content.

20. The medium as recited in claim 19, wherein the PodID comprises segment group information (SegmentGroupInformation) for providing information of a segment group.

21. The medium as recited in claim 20, wherein the SegmentGroupInformation comprises an identifier (groupID) for the segment group.

22. The medium as recited in claim 20, wherein the SegmentGroupInformation comprises reference information (ProgramRef) for referring a program including the segment group.

23. The medium as recited in claim 20, wherein the SegmentGroupInformation comprises group type information (GroupType) for representing a common attribute of the segment group.

24. The medium as recited in claim 23, wherein the GroupType comprises insertion point information of an insertion points type for inserting a predetermined content.

25. The medium as recited in claim 20, wherein the PodID is Content Reference Identifier (CRID) type.

26. The medium as recited in claim 19, wherein the PodID comprises segment information (SegmentInformation) for providing information of a segment.

27. The medium as recited in claim 26, wherein the SegmentInformation comprises an identifier (segmentID) for the segment.

28. The medium as recited in claim 26, wherein the SegmentInformation comprises reference information (ProgramRef) for referring a program including the segment.

29. The medium as recited in claim 26, wherein the PodID is Content Reference Identifier (CRID) type.

30. The medium as recited in claim 26, wherein the SegmentInformation comprises location information of the Pod, wherein the location information of the Pod is provided by segment location information (SegmentLocator).

31. The medium as recited in claim 19, wherein the PodID is Uniform Resource Identifier (URI) type.
